(19) United States
(12) Patent Application Publication
(10) Pub. No.: US 2007/0129098 A1
(43) Pub. Date: Jun. 7, 2007

(54) Device and method for determining a user-desired mode of inputting speech

(75) Inventors: Yan M. Cheng, Inverness, IL (US); Ted Mazurkiewicz, Lake Zurich, IL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/295,198

(22) Filed: Dec. 6, 2005

(51) Int. Cl. H04M 1/00; H04B 1/38

(52) U.S. Cl. 455/550.1; 455/563

(57) ABSTRACT

A device and method of detecting a mode of inputting speech to a wireless device includes a processor (220) communicatively coupled to a user input (218), an audio input (206), a timer (211), and a speech processor (230). The processor (220) monitors the user input (218) and, upon detection of a first change in state of the user input (218), opens an input channel from the audio input (206) to the speech processor (230), monitors the timer (211) for an elapsed time, and monitors the user input (218) for a second change of state. Upon detection of the second change of state after a predetermined amount of time elapses, the input channel is closed. Upon detection of the second change of state before a predetermined amount of time elapses, the user input is monitored for a third change of state and upon detecting the third change of state, the input channel is closed.

### FIELD OF THE INVENTION

The present invention generally relates to the field of speech recognition systems, and more particularly relates to systems that detect a user's intent to utilize a push-and-hold audio input mode or a push-and-release audio input mode.

### BACKGROUND OF THE INVENTION

With the advent of pagers, mobile phones, and other wireless devices, the wireless service industry has grown into a multi-billion-dollar industry. The bulk of the revenues for Wireless Service Providers (WSPs) originate from subscriptions. As such, a WSP's ability to run a successful network is dependent on the quality of service provided to subscribers.

Recently, speech recognition has enjoyed success in the wireless service industry. Speech recognition is used for a variety of applications and services. For example, a wireless service subscriber can be provided with a speed-dial feature whereby the subscriber speaks the name of a recipient of a call into the wireless device. The recipient's name is recognized using speech recognition and a call is initiated between the subscriber and the recipient. In another example, a caller information service (e.g., 411) can utilize speech recognition to recognize the name and/or a location of a recipient to whom a subscriber is attempting to call. Further uses of speech recognition can be for performing functions within the device itself, such as setting the ring mode to vibrate, adjusting the ring volume, setting a calendar event, and many others.

To initiate a speech-recognition mode, a user must indicate to the device that the mode is desired. Conventional methods of initiating the speech recognition mode have been to either press and hold (PAH) a button or to press and release (PAR) the button. With the PAH method, the device inputs the user's audio stream as long as the button remains depressed. Once the button is released, the device immediately stops accepting the audio input. In the PAR mode, a user presses the button and releases the button quickly thereafter. Upon the initial button depression, the device begins inputting an audio stream. The device continues to accept the audio stream until the button is again depressed by the user, or by another form of user input from the user.

There are many occasions when one of the two methods is advantageous over the other. For instance, while a user's hands are needed, such as while driving, holding a button down (PAH) for an extended period of time is not practical. In this situation, PAR is ideal. In other situations, such as in a loud environment, a user may want to input a short amount of speech and indicate to the device that it should immediately cease recording. In this situation, PAH is ideal. Unfortunately, prior-art devices offer only one of the above-described speech recognition input modes in a single device. No devices are available that can intelligently detect a user's intent to use one mode over the other.

Therefore a need exists to overcome the problems with the prior art as discussed above.

### SUMMARY OF THE INVENTION

Briefly, in accordance with the present invention, disclosed is a wireless device comprising: a processor for processing instructions; a user input communicatively coupled to the processor; an audio input communicatively coupled to the processor; a timer communicatively coupled to the processor; and a speech processor communicatively coupled to the processor, and wherein the processor monitors the user input and, upon detection of a first change in state of the user input, operates to: open an input channel from the audio input to the speech processor; monitor the timer for an elapsed time; monitor the user input for a second change in state, and upon detection of the second change in state after a predetermined amount of time elapses, close the input channel; and upon detection of the second change of state before the predetermined amount of time elapses, monitor an automatic speech-end-point detector or the user input for a third change in state, and upon detecting the third change in state of the user input or a speech end-point, close the input channel.

According to another embodiment, a method is provided for detecting a mode of inputting speech to a wireless device, the method comprising: detecting a first change of state of a user input; opening an input channel from an audio input to a speech processor; monitoring a timer for an elapsed time; monitoring the user input for a second change of state and upon detection of the second change of state occurring after a predetermined amount of time has elapsed since the first change of state was detected, closing the input channel; and upon detection of the second change of state occurring before the predetermined amount of time has elapsed since the first change of state was detected, monitoring an automatic speech-end-point detector or the user input for a third change of state and upon detecting the third change of state of the user input or a speech-end-point, closing the input channel.

### BRIEF DESCRIPTION OF THE DRAWINGS

FIG. 1 is a block diagram of a wireless communication system according to an embodiment of the present invention.

FIG. 2 is a block diagram illustrating a wireless device for a wireless communication system according to an embodiment of the present invention.

FIG. 3 is an operational flow diagram showing an overall speech recognition input method selection process according to an embodiment of the present invention.

FIG. 4 is a block diagram of an information processing system useful for implementing an embodiment of the present invention.

### DETAILED DESCRIPTION

The present invention, according to a preferred embodiment, advantageously overcomes problems with the prior art by providing a device that is capable of entering into a push-and-hold mode of speech input and a push-and-release mode of speech input, whereby the device is able to intelligently detect a user's intent to utilize one mode over the other.

Overview

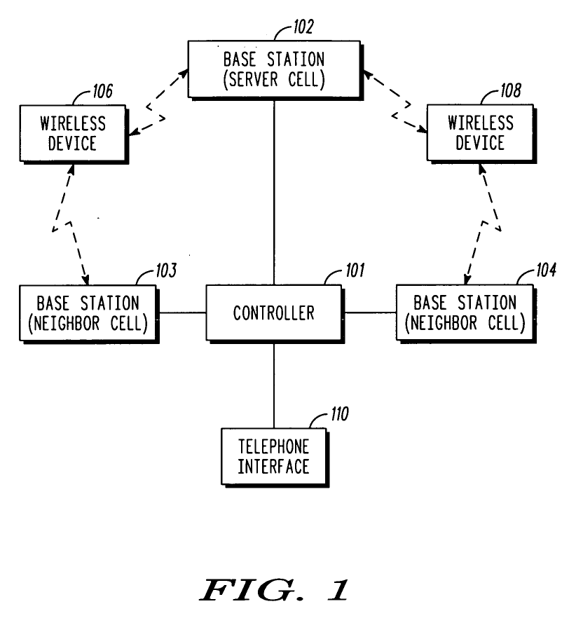

FIG. 1 is a detailed block diagram of a wireless communication system. The wireless communication system of FIG. 1 includes a controller 101 coupled to base stations 102, 103, and 104. In addition, the wireless communication system of FIG. 1 is interfaced to an external network through a telephone interface 110. The base stations 102, 103, and 104 individually support portions of a geographic coverage area containing subscriber units or transceivers (i.e., wireless devices) 106 and 108. The wireless devices 106 and 108 interface with the base stations 102, 103, and 104 using a communication protocol, such as CDMA, FDMA, GPRS, and GSM.

The geographic coverage area of the wireless communication system of FIG. 1 is divided into regions or cells, which are individually serviced by the base stations 102, 103, and 104 (also referred to herein as cell servers). A wireless device operating within the wireless communication system selects a particular cell server as its primary interface for receive and transmit operations within the system. For example, wireless device 106 has cell server 102 as its primary cell server, and wireless device 108 has cell server 104 as its primary cell server. Preferably, a wireless device selects a cell server that provides the best communication interface into the wireless communication system. Ordinarily, this will depend on the signal quality of communication signals between a wireless device and a particular cell server.

As a wireless device moves between various geographic locations in the coverage area, a hand-off or hand-over may be necessary to another cell server, which will then function as the primary cell server. A wireless device monitors communication signals from base stations servicing neighboring cells to determine the most appropriate new server for hand-off purposes.

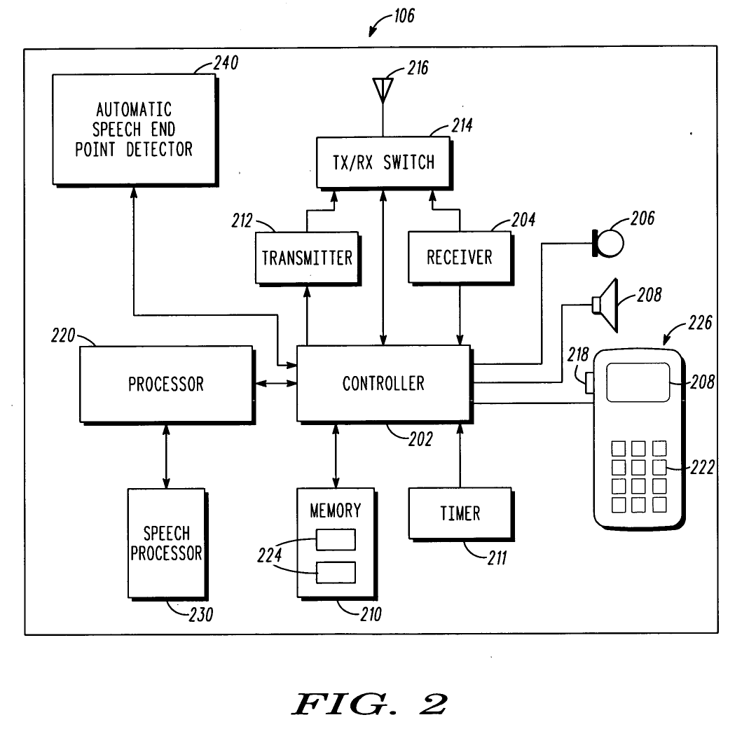

FIG. 2 is a block diagram illustrating a wireless device for a wireless communication system according to a preferred embodiment of the present invention. FIG. 2 is a more detailed block diagram of the wireless device 106 described with reference to FIG. 1. In one embodiment of the present invention, the wireless device 106 is a two-way radio capable of receiving and transmitting radio frequency signals over a communication channel under a communications protocol such as CDMA, FDMA, CDMA, GPRS or GSM. The wireless device 106 operates under the control of a controller 202 which switches the wireless device 106 between receive and transmit modes. In receive mode, the controller 202 couples an antenna 216 through a transmit/receive switch 214 to a receiver 204. The receiver 204 decodes the received signals and provides those decoded signals to the controller 202. In transmit mode, the controller 202 couples the antenna 216, through the switch 214, to a transmitter 212.

The controller 202 operates according to instruction code disposed in a memory 210 of the wireless device 106. Memory 210 is Flash memory, other non-volatile memory, random access memory (RAM), dynamic random access memory (DRAM) or the like. Various modules 224 of code stored in the memory 210 are used for instantiating various functions.

To allow the user to operate the wireless device 106, and receive information from the wireless device 106, the wireless device 106 includes a user interface 226, including a display 228, and a keypad 222. Furthermore, the wireless device 106 is provided with a button 218 for, as will be explained in detail below, placing the wireless device 106 into and out of speech recognition mode. The button 218, keypad 222, screen 228, and other areas of the user interface 226 can be used as user inputs for communicating with the wireless device 106. These areas of the user interface 226, such as the keypad 222, are used to place the wireless device 106 into and out of speech recognition modes.

A timer module 211 provides timing information to the controller 202 to keep track of timed events. Further, the controller 202, which is coupled to the user interface 226, can utilize the time information from the timer module 211 to keep track of elapsed time between events, such as the length of time a button is depressed.

The controller 202 is communicatively coupled to a processor 220 which processes instructions. The processor 220 can perform operations, such as monitor the timer module 211 for determining the passage of an elapsed time or the state of a user input and number of state changes of a user input. In various embodiments of the present invention, the processor 220 is a single processor or more than one processor for performing the tasks described above.

The wireless device 106 also includes a speech processor 230. The speech processor 230 can be a separate processor as shown in FIG. 2, or software running on the processor 220. The speech processor 230 performs various functions such as the functions attributed to speech recognition. The speech processor 230 receives speech signals from a channel that runs from the microphone 206 to the speech processor 230 through zero or more intermediate components within the wireless device 106. In one embodiment of the present invention, the processor 220 and/or speech processor 230 includes a digital to analog and/or an analog to digital converter (not shown).

The speech processor 230 is able to interpret a user's speech based on a set of instructions that are provided within the wireless device and perform various functions based on the same or a separate set of instructions that are provided within the wireless device. The instructions can be software based and stored in the memory 210 or can be hardwired.

To initiate the speech recognition mode, the user utilizes the user interface 226. For the present discussion, the button 218 will be discussed for speech recognition initiation and termination, although in practice, any of the keys 222, or a touch-sensitive screen 228, or other devices can be used, as should be obvious to those of skill in the art in view of the present discussion. The button 218 is a two-way switch that is monitorable in both states. Therefore, the controller can detect which state the switch is in at any given time.

A first method of initiating a speech recognition mode is to press and hold (PAH) the button 218. As long as the button 218 is depressed, the wireless device 106 inputs an audio stream through the microphone 206 and passes it to the speech processor 230 for interpretation. In an embodiment of the present invention, as soon as the button 218 is depressed, the controller 202 monitors elapsed time by utilizing the timer 211. If a pre-selected amount of time passes after the button is depressed, but before it is released, it is determined that the user intends for the wireless device 106 to be in a PAH mode. That is, the user is holding the button longer than would be expected if the user were to simply press the button and release it. In the PAH mode, the input channel through the microphone 206 to the speech processor 230 is cut off as soon as the button is released.

The second method of initiating a speech recognition mode is to press and release (PAR) the button 218. With the PAR method, a user presses the button and releases it quickly thereafter. As described above, upon the initial button depression, the controller begins monitoring elapsed time. If the button 218 is released before a threshold time limit is reached, for instance, one second, the wireless device 106 interprets the action as an indication of the user's intent to enter into a PAR mode. In the PAR mode, the device 106 will continue to maintain an open audio input channel from the microphone 206 to the speech processor 230 after the button is released. The audio input channel will input an audio stream that includes the user's speech. According to one exemplary embodiment, while the device is inputting the user's speech in the PAR mode, it is also monitoring an automatic speech-end-point detector 240 that is able to determine when speech has ended. The determination can be based on a duration of no speech exceeding a threshold or can be made upon detecting a specific word or group of words, such as “end call.” In other embodiments, the device monitors one or more alternative user inputs, such as from the keypad 222 or a voice instruction, to stop inputting speech. Once the end of speech has been detected in 240, or, depending on the embodiment, the device recognizes a user input indicating a desire to cease inputting speech, the device closes the audio input channel and stops inputting audio.

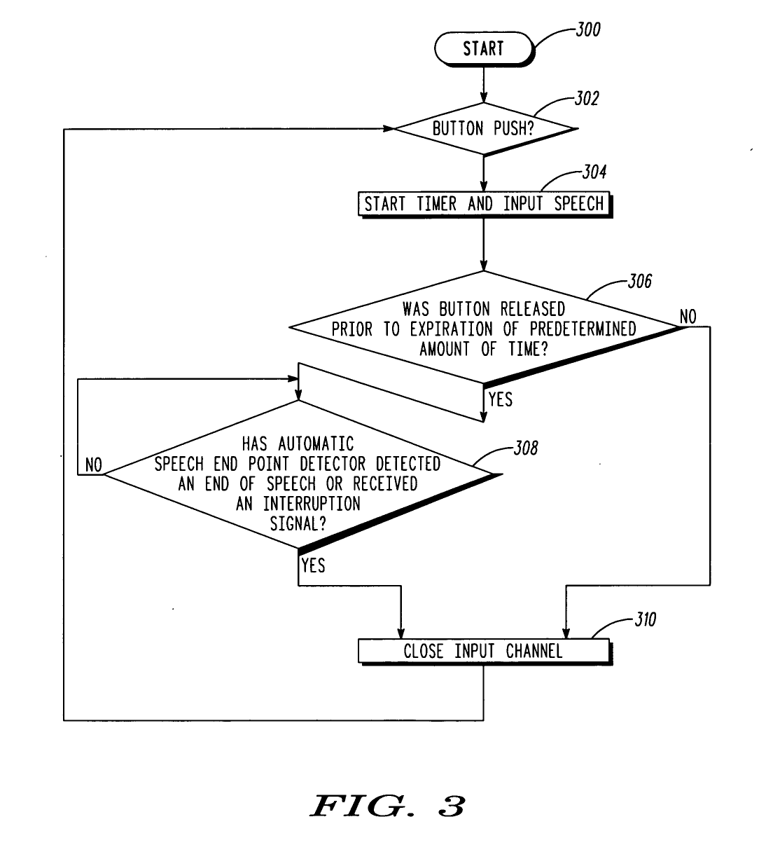

FIG. 3 is a flow diagram illustrating an operation of the wireless device 106 in a preferred embodiment of the present invention. The flow starts at step 300 and moves directly to step 302 where the wireless device detects a button push. Upon detection of the button push, flow moves to step 304, where the device immediately starts a timer and simultaneously starts inputting a speech stream through its microphone. In step 306, the device determines if the button was released prior to the expiration of a predetermined amount of time. If the button was released prior to the expiration of the predetermined amount of time, the flow moves to step 308 and continues to input audio while it waits for either the automatic speech end-point detector to detect the end of speech or for an interruption signal, for instance, due to exceeding maximum length of input audio. Upon detecting, by the Automatic Speech-End-Point Detector, the end of speech, or an interruption signal, the flow moves to step 310 where the input channel is closed and audio is no longer input to the device. The flow then returns to step 302 where the button is monitored for subsequent pushes.

If, in step 306, the device determined that the button was released after the predetermined amount of time, the flow moves to step 310 where the input channel is closed and audio is no longer input to the device. The flow then returns back up to step 302 where the button is monitored for subsequent pushes.

In another embodiment of the present invention, the wireless device 106 can determine the user-desired speech input method by considering not just the way in which the user input button is depressed and released, but by also considering the context of the user's environment. For instance, in environments where the ambient noise level is high, a user may be more likely to desire the PAH method of inputting speech. The device, in this situation, may monitor the ambient noise levels and adjust the predetermined time limits for determining PAH versus PAR mode. Specifically, the predetermined time may be reduced. In another embodiment, the wireless device 106 is equipped with an accelerometer and is able to detect if the user is moving, e.g., accelerating or slowing rapidly. Situations like this may arise when a user is driving an automobile. The device 106 may assume the user would prefer a PAR mode in this situation and will increase the predetermined amount of time that must elapse before the PAH mode is recognized. Other factors that may be considered are the device's orientation and location. These parameters can be detected, among other ways, through use of leveling devices and GPS devices. Additionally, a user can configure the device for user preferences of either mode of speech input, i.e., either PAH or PAR, depending on the particular context that the wireless device may detect it is in. For example, the detection of movement, such as in a moving car, may be configured to use either PAH mode or PAR mode.

Exemplary Implementations

The present invention can be realized in hardware, software, or a combination of hardware and software in clients 106, 108 or server 102 of FIG. 1. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product (in clients 106 and 108 and server 102), which comprises all the features enabling the implementation of the methods described herein, and which, when loaded in a computer system, is able to carry out these methods. Computer program means or computer program as used in the present invention indicates any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer-readable medium, allowing a computer system, to read data, instructions, messages or message packets, and other computer-readable information from the computer-readable medium. The computer-readable medium may include non-volatile memory, such as ROM, Flash memory, Disk drive memory, CD-ROM, and other permanent storage. Additionally, a computer-readable medium may include, for example, volatile storage such as RAM, buffers, cache memory, and network circuits. Furthermore, the computer-readable medium may comprise computer-readable information in a transitory state medium such as a network link and/or a network interface, including a wired network or a wireless network, that allow a computer system to read such computer-readable information.

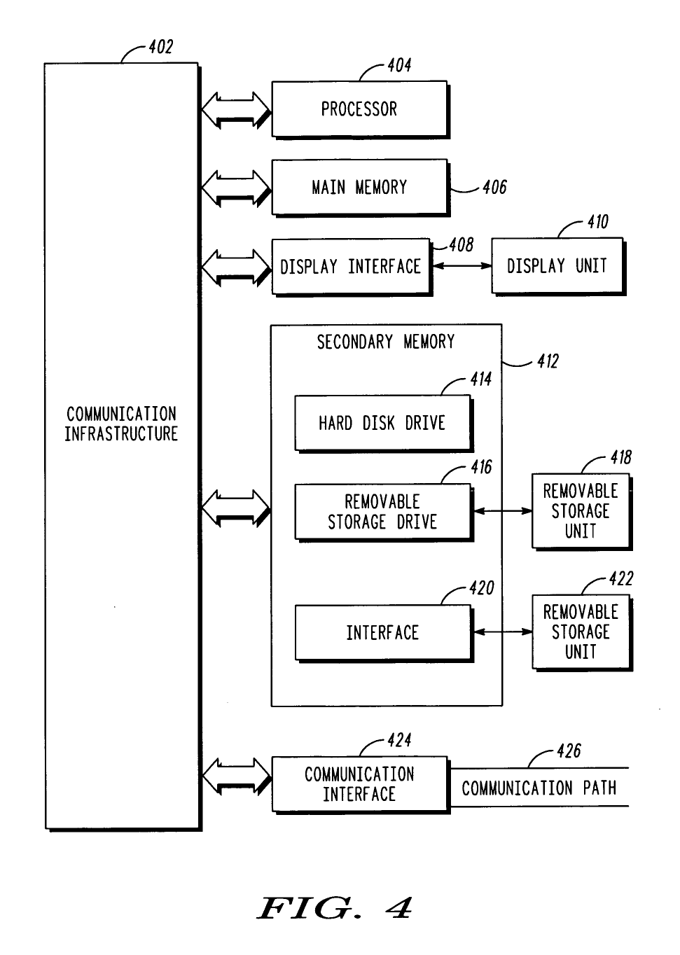

FIG. 4 is a block diagram of a computer system useful for implementing an embodiment of the present invention. The computer system of FIG. 4 is a more detailed representation of clients 106 and 108 and a server 102. The computer system of FIG. 4 includes one or more processors, such as processor 404. The processor 404 is connected to a communication infrastructure 402 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 408 that forwards graphics, text, and other data from the communication infrastructure 402 (or from a frame buffer not shown) for display on the display unit 410. The computer system also includes a main memory 406, preferably random access memory (RAM), and may also include a secondary memory 412. The secondary memory 412 may include, for example, a hard disk drive 414 and/or a removable storage drive 416, representing a floppy disk drive, a magnetic tape drive, an optical disk drive, etc. The removable storage drive 416 reads from and/or writes to a removable storage unit 418 in a manner well known to those having ordinary skill in the art. Removable storage unit 418, represents a floppy disk, magnetic tape, optical disk, etc., which is read by and written to by removable storage drive 416. As will be appreciated, the removable storage unit 418 includes a computer usable storage medium having stored therein computer software and/or data.

In alternative embodiments, the secondary memory 412 may include other similar means for allowing computer programs or other instructions to be loaded into the computer system. Such means may include, for example, a removable storage unit 422 and an interface 420. Examples of such may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to the computer system.

The computer system may also include a communications interface 424. Communications interface 424 allows software and data to be transferred between the computer system and external devices. Examples of communications interface 424 may include a modem, a network interface (such as an Ethernet card), a communications port, a PCMCIA slot and card, etc. Software and data transferred via communications interface 424 are in the form of signals which may be, for example, electronic, electromagnetic, optical, or other signals capable of being received by communications interface 424. These signals are provided to communications interface 424 via a communications path (i.e., channel) 426. This channel 426 carries signals and may be implemented using wire or cable, fiber optics, a phone line, a cellular phone link, an RF link, and/or other communications channels.

In this document, the terms “computer program medium,” “computer-usable medium,” “machine-readable medium” and “computer-readable medium” are used to generally refer to media such as main memory 406 and secondary memory 412, removable storage drive 416, a hard disk installed in hard disk drive 414, and signals. These computer program products are means for providing software to the computer system. The computer-readable medium allows the computer system to read data, instructions, messages or message packets, and other computer-readable information from the computer-readable medium. The computer-readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer-readable medium may comprise computer-readable information in a transitory state medium such as a network link and/or a network interface, including a wired network or a wireless network, that allow a computer to read such computer-readable information.

Computer programs (also called computer control logic) are stored in main memory 406 and/or secondary memory 412. Computer programs may also be received via communications interface 424. Such computer programs, when executed, enable the computer system to perform the features of the present invention as discussed herein. In particular, the computer programs, when executed, enable the processor 404 to perform the features of the computer system. Accordingly, such computer programs represent controllers of the computer system.

### CONCLUSION

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A wireless device comprising:
a processor for processing instructions;
a user input communicatively coupled to the processor;
an audio input communicatively coupled to the processor;
a timer communicatively coupled to the processor; and
a speech processor communicatively coupled to the processor,
wherein the processor monitors the user input and, upon detection of a first change in state of the user input, operates to:
open an input channel from the audio input to the speech processor;
monitor the timer for an elapsed time;
monitor the user input for a second change in state, and:
upon detection of the second change in state after a predetermined amount of time elapses, close the input channel; and
upon detection of the second change of state before the predetermined amount of time elapses, monitor an automatic speech-end-point detector or the user input for a third change in state, and
upon detecting the third change in state of the user input or a speech-end-point, close the input channel.

2. The wireless device according to claim 1, wherein the user input comprises a button, a keypad, or a touch screen.

3. The wireless device according to claim 1, wherein the first change of state comprises a depression of a button.

4. The wireless device according to claim 1, wherein the second change of state comprises a release of a depressed button.

5. The wireless device according to claim 1, wherein the speech processor is a software application executed in the processor.

6. A method for detecting a mode of inputting speech to a wireless device, the method comprising:
detecting a first change of state of a user input;
opening an input channel from an audio input to a speech processor;
monitoring a timer for an elapsed time;
monitoring the user input for a second change of state and:
upon detection of the second change of state occurring after a predetermined amount of time has elapsed since the first change of state was detected, closing the input channel; and
upon detection of the second change of state occurring before the predetermined amount of time has elapsed since the first change of state was detected, monitoring an automatic speech-end-point detector or the user input for a third change of state and upon detecting the third change of state of the user input or a speech-end-point, closing the input channel.

7. The method according to claim 6, wherein the user input comprises a button, a keypad, or a touch screen.

8. The method according to claim 6, wherein the first change of state comprises a depression of a button.

9. The method according to claim 6, wherein the second change of state comprises a release of a depressed button.

10. The method according to claim 6, further comprising:
receiving a speech stream at the audio input; and
processing the speech stream with the speech processor to recognize instructions.

11. A computer program product for detecting a mode of inputting speech to a wireless device, the computer program product comprising:
a storage medium readable by a processing circuit and storing instructions for execution by the processing circuit for performing a method comprising:
detecting a first change of state of a user input;
opening an input channel from an audio input to a speech processor;
monitoring a timer for an elapsed time;
monitoring the user input for a second change of state and:
upon detection of the second change of state occurring after a predetermined amount of time has elapsed since the first change of state was detected, closing the input channel; and
upon detection of the second change of state occurring before the predetermined amount of time has elapsed since the first change of state was detected, monitoring an automatic speech-end-point detector or the user input for a third change of state and upon detecting the third change of state of the user input or a speech-end-point, closing the input channel.

12. The computer program product according to claim 11, wherein the user input is a button, a keypad, or a touch screen.

13. The computer program product according to claim 11, wherein the first change of state is a depression of a button.

14. The computer program product according to claim 11, wherein the second change of state is a release of a depressed button.

15. The computer program product according to claim 11, further comprising:
receiving a speech stream at the audio input; and
processing the speech stream with the speech processor to recognize instructions.
